(19) United States
(12) Patent Application Publication
(10) Pub. No.: US 2019/0309973 A1
(43) Pub. Date: Oct. 10, 2019

(54) METHOD FOR DETECTING CLOG IN AC SYSTEM HEAT EXCHANGE OR AIR FILTER

(71) Applicant: ECOER INC., Mclean, VA (US)

(72) Inventor: Jianliang Zhang, Beijing (CN)

(21) Appl. No.: 16/468,803

(22) PCT Filed: Dec. 29, 2016
(86) PCT No.: PCT/US16/69347

§ 371 Date: Jun. 12, 2019

(51) Int. Cl. F24F 11/39; G05B 23/02

(52) U.S. Cl. CPC F24F 11/39; F24F 2110/12; G05B 23/0213

(57) ABSTRACT

The present disclosure relates to the field of air conditioning technology. In particular, it involves a method for detecting clog in ac system outdoor or indoor heat exchange or air filter.

The present application is a national stage of PCT/US 16/69347, filed on Dec. 29, 2016, with its specification incorporated by reference, but otherwise the same. The disclosure below will assume common knowledge of air conditioning and heat pump as well as their heat exchange principle in terms of achieving cooling and heating. Therefore, when discussing particular AC inner working, it is applied to heat pump collectively. The discussion will also treat compressor speed and compressor RPS (rotation per second) interchangeably as well.

### BACKGROUND OF THE DISCLOSURE

AC system is prone to clog after extensive use. Both the outdoor unit and indoor unit as well as air filter are accumulating dirt or can be blocked by debris, causing clog. When the accumulated dirt or debris is not cleared for a while, the AC system will suffer loss of cooling/heating capacity, increasing electricity consumption. Or worse, the interrupted heat exchange process could cause refrigerant pressure be out of range, and damage the compressor as a result.

On the other hand, many users lack the experience of maintenance. This is also a result of lack of understanding on when the indoor or outdoor heat exchange or filter need to be cleaned.

Existing technical implementation utilizes a timing method to inform users. Basically, a timer is used to keep track of total run time, and based on the total run time exceeding a preset parameter, reminder is provided. But there are problems with this method. For one, because there is no objective relationship between timing and actual dirt condition, it is only a suggestion. Because each system environment is different, there might be times when it is not yet necessary to clean at the sound of the timer. For another, because the lack of communication channel—other than the on and off signal, between the outdoor unit and the indoor unit, complex communication upgrade to the timer method would be impossible.

### SUMMARY OF THE DISCLOSURE

Based on the above deficiencies, an objective of the disclosure is to provide a new detection method implementation, so that this new implementation will provide accurate estimation on dirt accumulation on indoor/outdoor heat exchange and filter, so that a warning on cleaning is needed when necessary or to stop the system from damaging itself. This application can work with systems that only have on/off signals between outdoor and indoor units, where complex communication on dirt accumulation status via sensor is impossible.

### Method of Outdoor Heat Exchange Coefficient Calculation

To achieve the above objective in detecting AC system dirt accumulation, a method for calculating heat exchange efficiency is disclosed.

After system installation or maintenance, several operation cycles on different speed and temperature are needed in order to establish a baseline for the outdoor heat exchange coefficient Kh0.

Then from an operation perspective, a warning threshold is established as a percentage X %. At each start of the subsequent operation cycle, the method of calculating the actual outdoor heat exchange coefficient is performed. This coefficient Kh is compared with Kh0 times X %. When Kh<Kh0×X %, an occurrence register is increased. When the register has accumulated more than n number of occurrences, it arises to an indication of substantial clog, therefore, it becomes a clear indication for maintenance.

Method of Indoor Heat Exchange Coefficient Calculation

After system installation or maintenance, several operation cycles on different outdoor temperatures are needed in order to establish a baseline for the indoor cooling capacity of qc0 at different temperatures.

Next, based on looking up on AC compressor low pressure PL and the refrigerant average saturation temperature Te, a baseline indoor heat exchange coefficient Kc0 is established.

Then from an operation perspective, a warning threshold is established as a percentage X %. At each start of the subsequent operation cycle, the method of calculating the actual indoor heat exchange coefficient is performed. This coefficient Kh is compared with Kh0 times X %. When Kh<Kh0×X %, an occurrence register is increased. When the register has accumulated more than n number of occurrences, it arises to an indication of substantial clag, therefore, it becomes a clear indication for maintenance.

### BRIEF DESCRIPTION OF THE DRAWINGS

FIG. 1 shows a flow chart of the first embodiment of the AC outdoor unit clog detection method of this disclosure.

FIG. 2 shows a timing diagram of an AC system implementing the detection method of this disclosure.

FIG. 3 shows configuration diagram of an AC system implementing the detection method of this disclosure.

FIG. 4 shows a flow chart of the second embodiment of the AC indoor unit clog detection method of this disclosure.

### DETAILED DESCRIPTION OF THE DISCLOSURE

### First Embodiment

This embodiment is for detecting clogging condition for the outdoor heat exchange. As an illustration example, in cooling mode, the method is as follows.

Outdoor Unit Heat Exchange Coefficient Kh Calculation

Variable G is defined as the system refrigerant circulation flow rate (in kg/s). This flow rate data is obtained from this compressor regression model:

G=f(PL,PH,Ts,RPS).

wherein, PL is AC compressor low pressure obtained by low-pressure sensor, and PH is AC compressor high pressure obtained by high-pressure sensor, Ts is return air temperature sensor value obtained, RPS for the AC compressor speed. These parameter data are real time data from operation, so their values can be corresponding to function of t. Therefore, the circulating refrigerant flow of G can also be obtained in real time by calculation.

From cooling thermodynamic, Hour is defined as fluid outlet enthalpy, where its value can be obtained from the refrigerant's properties table:

Hₒᵤₜ=f(PH,Tₒᵤₜ).

This is possible because fluid outlet temperature Tₒᵤₜ can be obtained from fluid outlet temperature sensor, and the PH value can be obtained from the high pressure sensor.

Similarly, Hᵢₙ is defined as fluid inlet enthalpy, where its value can be obtained from the refrigerant's properties table:

Hᵢₙ=f(PL,Ts).

This is also possible because fluid inlet temperature Ts can be obtained from fluid inlet temperature sensor, and the PL value can be obtained from the low pressure sensor.

The system cooling capacity q can be expressed as a function of:

q=G×(Hₒᵤₜ−Hᵢₙ).

Correspondingly, H_{dis} is defined as compressor discharge outlet enthalpy, where its value can be obtained from the refrigerant's properties table:

H_{dis}=f(PH,T_{d}).

Same as before, this is possible because compressor discharge outlet temperature T_{d} can be obtained from compressor outlet temperature sensor, and the PH value can be obtained from the high pressure sensor. Therefore, cooling capacity q can be expressed as a function of:

q=G×(Hₒᵤₜ−Hᵢₙ).

Compressor output power P normally can be obtained from the control circuit where voltage and current are measured, where:

P=Voltage×Current.

In this case, compressor output power can also be expressed in compressor model, as:

P=G×(H_{dis}−Hᵢₙ).

So at the end, outdoor unit heat exchange coefficient Kh is derived as:

Kh=(q+P)/(Tc−Ta),

where Ta is outdoor temperature, Tc is the coolant saturation temperature on a high pressure PH reading, and Kh's unit is kw/° C.

Clog Detection Method for Heat Exchange

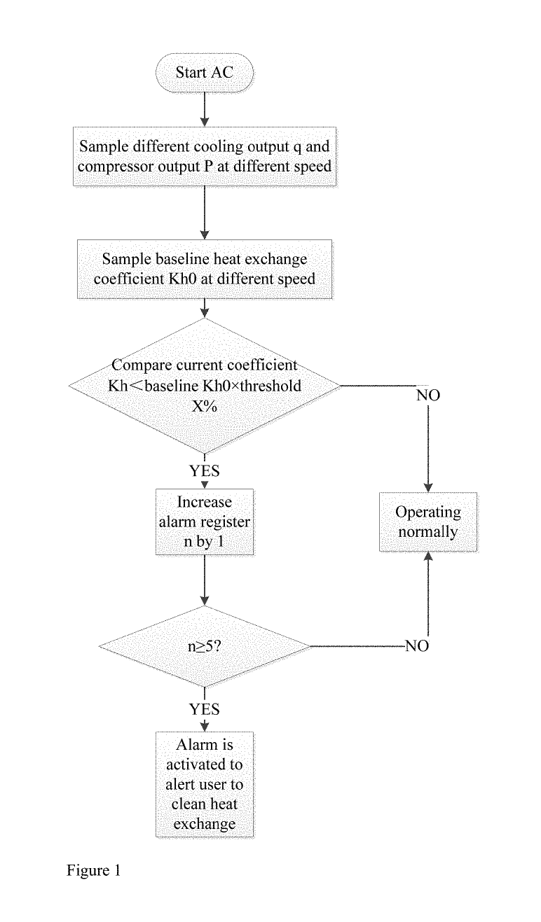

FIG. 1 shows a flow chart of the first embodiment of the AC outdoor unit clog detection method of this disclosure. In this embodiment, the heat exchange does not yet need to be clean when coefficient Kh is within a range. Only after the heat exchange coefficient is outside of the range, AC unit would need to inform user to clean the outdoor heat exchange.

The details of the method are as follows.

After system installation or maintenance, several operation cycles on different speed and temperature are needed in order to establish a baseline for the outdoor heat exchange coefficient Kh0 by using averages on values obtained at different speed. For example, one can measure 7 times the outdoor unit heat exchange coefficient Kh0 each at a different speed.

Then from an operation perspective, a warning threshold is established as a percentage X %. At each start of the subsequent operation cycle, the method of calculating the actual outdoor heat exchange coefficient is performed. This coefficient Kh is compared with Kh0 times X %. When Kh<Kh0×X %, an occurrence register is increased. When the register has accumulated more than n number (for example 5) of occurrences, it arises to an indication of substantial clog, therefore, it becomes a clear indication for maintenance.

In this embodiment, as an example, the alarm threshold X % can be set at 90%. The value of X % and the occurrence value n can be set by the users, or can be set by a remote server. Moreover, X % can be set based on the condition of user environment. For example, when air in the user environment is relatively clean, the alarm level X % can be lower a bit, or when the air in the user environment is dirty, X % can be increased.

### Second Embodiment

This embodiment is for detecting clogging condition for the indoor heat exchange or air filter. As an illustration example, in cooling mode, the method is as follows.

Indoor Unit Heat Exchange Coefficient Kc Calculation

Because indoor unit heat exchange coefficient is related to indoor heat load and heat exchange temperature differential, and the fact that the indoor heat load is also related to the outdoor temperature, therefore, once the outdoor temperature is obtained accurately, then by looking up the heat exchange temperature differential, the heat exchange coefficient Kc is finally obtained. This is also based on the outdoor cooling output being calculated and used as the indoor cooling load for a full operating cycle.

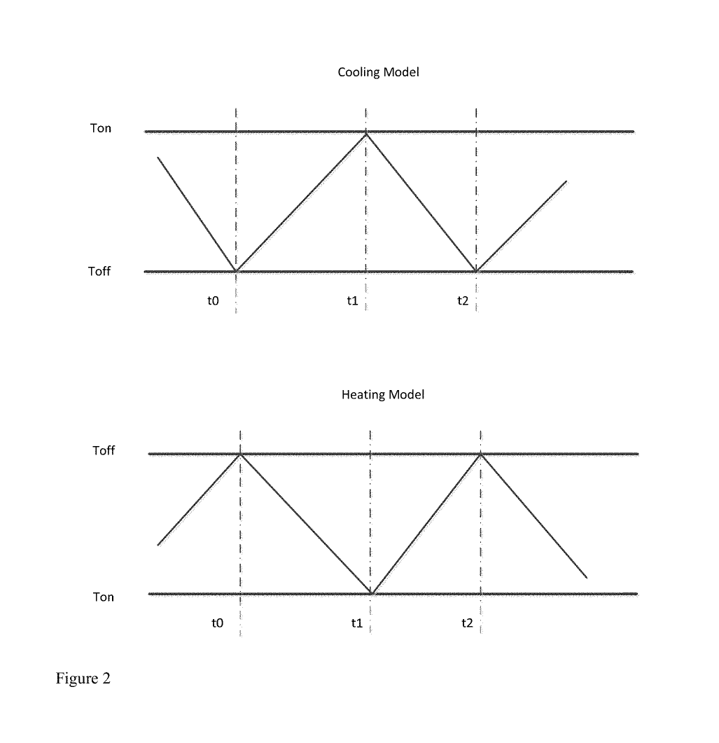

As showed in FIG. 2 of the timing diagram of an AC system implementing the detection method of this disclosure, Tₒₙ is defined as the room temperature at the time of the on signal is given by the indoor unit or the thermostat. Also defined is T_{off}, which is the room temperature at the time of the off signal given by the indoor unit or the thermostat. Continuing on, t₀ is defined as the time when the prior AC compressor off signal is given, t₁ is defined as the time when this cycle's AC compressor on signal will be given and t₂ is defined as the time when this cycle's AC compressor off signal will be given. Therefore, from t₀ to t₂ is the interval of the AC compressor operating cycle. In addition, Tₐ is defined as the average outdoor temperature for the time period between t₁ to t₂.

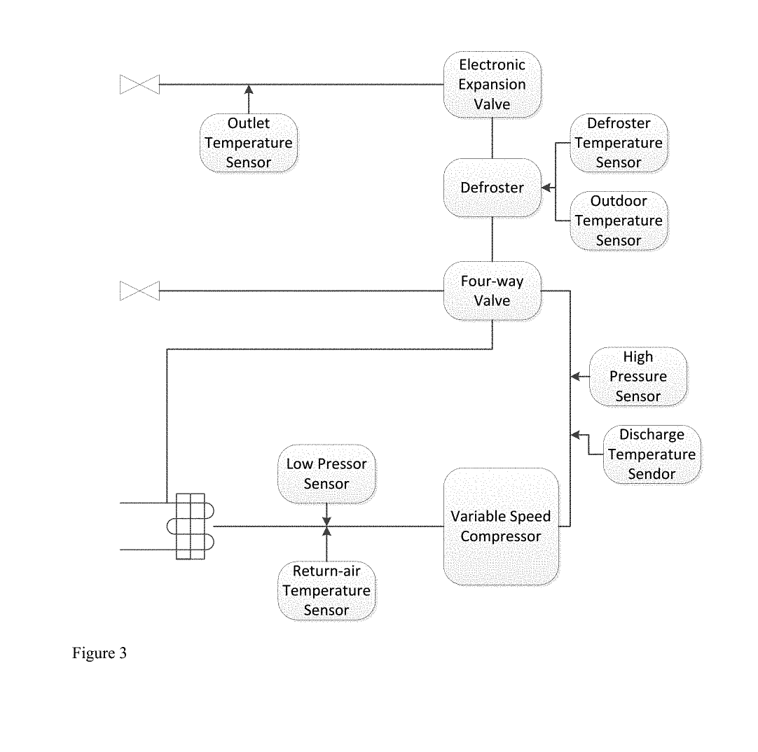

Then, from FIG. 3 the overall system configuration of this disclosure, the system model has the following characteristics.

Variable G is defined as the system refrigerant circulation flow rate (in kg/s). This flow rate data is obtained from this compressor regression model:

G=f(PL,PH,Ts,RPS).

wherein, PL is AC compressor low pressure obtained by low-pressure sensor, and PH is AC compressor high pressure obtained by high-pressure sensor, Ts is return air temperature sensor value obtained, RPS for the AC compressor speed. These parameter data are real time data from operation, so their values can be corresponding to function of t. Therefore, the circulating refrigerant flow of G can also be obtained in real time by calculation.

From cooling thermodynamic, Hₒᵤₜ is defined as fluid outlet enthalpy, where its value can be obtained from the refrigerant's properties table:

Hₒᵤₜ=f(PH,Tₒᵤₜ).

This is possible because fluid outlet temperature Tₒᵤₜ can be obtained from fluid outlet temperature sensor, and the PH value can be obtained from the high pressure sensor.

Similarly, Hᵢₙ is defined as fluid inlet enthalpy, where its value can be obtained from the refrigerant's properties table:

Hᵢₙ=f(PL,Ts).

This is also possible because fluid inlet temperature Ts can be obtained from fluid inlet temperature sensor, and the PL value can be obtained from the low pressure sensor.

The system cooling capacity q can be expressed as a function of:

q=G×(Hₒᵤₜ−Hᵢₙ).

Therefore, the cooling output function q(t) between t₁ and t₂ can be integrated to obtain the total cooling output Q, where

Q=∫ₜ₁^{t2}q(t)dt.

Therefore, the average cooling output qc between t₁ and t₂ is:

qc=Q/(t2−t1)

By taking an average value of qc on several operating cycles, one can obtain a baseline cooling output qc0 for a given outdoor temperature of the indoor unit. For example, this embodiment takes qc from 7 operating cycles.

For calculating average coolant saturation temperature Te the low pressure PL, one can use a weighted method. For example, when compressor is run for 20 min under Te=4° C. and 40 min under Te=6° C., then the average coolant saturation temperature Te at the low pressure PL is =4×20/60+6×40/60=5.3° C.

If we set 20° C. as the indoor temperature, and use outdoor cooling output as indoor cooling load, then baseline Kc0=qc0/(20−Te).

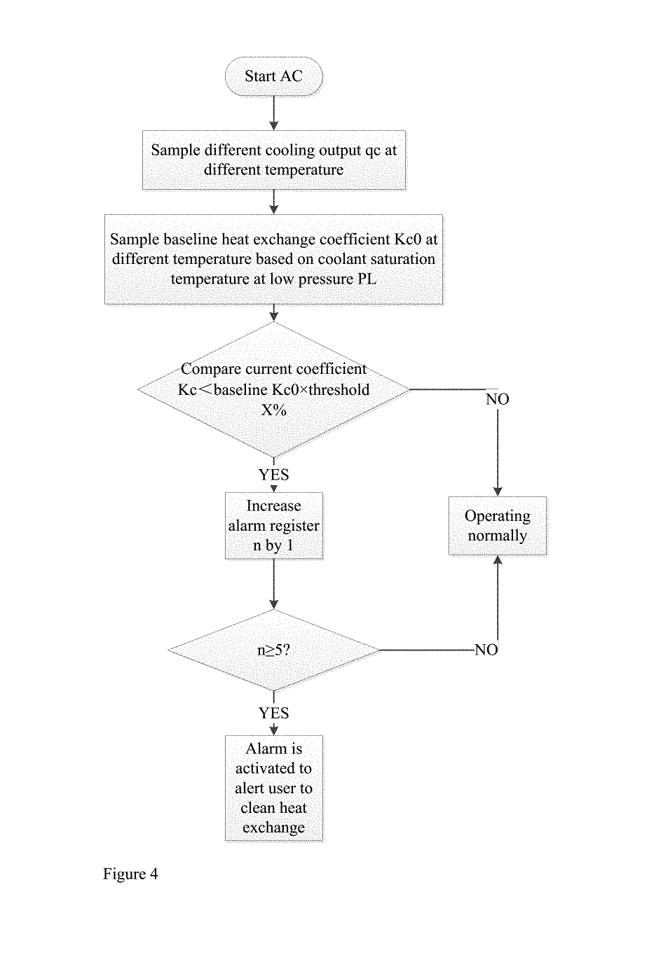

FIG. 4 shows a flow chart of the first embodiment of the AC indoor unit or filter clog detection method of this disclosure. In this embodiment, the heat exchange does not yet need to be clean when coefficient Kc is within a range. Only after the heat exchange coefficient is outside of the range, AC unit would need to inform user to clean the indoor heat exchange and filter.

The details of the method are as follows.

After system installation or maintenance, several operation cycles on different speed and temperature are needed in order to establish a baseline of outdoor cooling output qc0 at different outdoor temperature. This baseline of outdoor cooling output qc0 can be obtained by using averages on their qc values.

Next, by taking the average coolant saturation temperature Te at the low pressure PL into account, baseline indoor heat exchange coefficient Kc0 can be obtained.

Then from an operation perspective, a warning threshold is established as a percentage X %. At each start of the subsequent operation cycle, the method of calculating the actual indoor heat exchange coefficient is performed. This coefficient Kc is compared with Kc0 times X %. When Kc<Kc0×X %, an occurrence register is increased. When the register has accumulated more than n number (for example 5) of occurrences, it arises to an indication of substantial blockage, therefore, it becomes a clear indication for maintenance.

In this embodiment, as an example, the alarm threshold X % can be set at 90%. The value of X % and the occurrence value n can be set by the users, or can be set by a remote server. Moreover, X % can be set based on the condition of user environment. For example, when air in the user environment is relatively clean, the alarm level X % can be lower a bit, or when the air in the user environment is dirty, X % can be increased.

1. An AC control system (meaning both cooling and heating) comprises: AC calculation unit, database unit, operation data acquisition unit, wherein
the database unit is for storing and providing refrigerant property and outdoor temperature lookup data, which are needed by the AC calculation unit;
the operation data acquisition unit is for acquiring sensor data generated by outdoor unit, including outdoor air temperature, outdoor unit liquid outlet temperature, return inlet temperature, values of outdoor unit high pressure and low pressure; and
the AC calculation unit calculates actual heat exchange coefficient for actual operation timing cycle based on sensor data from operation data acquisition unit and lookup data from the database unit.

2. The AC control system according to claim 1, wherein
when the heat exchange coefficient is less than a baseline outdoor heat exchange coefficient by a threshold, sets off an alarm for heat exchange maintenance or stops the system; and
the threshold can be set by the user or a remote server or based on the environment.

3. The AC control system according to claim 2, wherein
the baseline heat exchange coefficient is set after installation or maintenance by sampling the system at a particular running condition and stored along with the running condition parameters as a lookup.

4. The AC control system according to claim 3, wherein
the heat exchange coefficient can be for indoor heat exchange or outdoor heat exchange; and
in case of outdoor heat exchange, additional compressor discharge pressure and compressor discharge temperature are part of the sensor data set for the calculation unit; and
in case of the AC system is variable speed system, addition compressor speed is part of the sensor data set for the calculation unit.

5. The AC control system according to claim 4, wherein
an alarm or system stop is triggered when actual heat exchange coefficient has been lacking from the baseline heat exchange coefficient for several times.

6. An AC (meaning both cooling and heating) control method, comprising:
calculating actual heat exchange coefficient for actual operation timing cycle based on sensor data from operation data and refrigerant lookup data, wherein the actual heat exchange coefficient is used to determine maintenance status.

7. The AC control method according to claim 6, further comprising:
calculating a baseline heat exchange coefficient after installation or maintenance; and
when the heat exchange coefficient is less than the baseline outdoor heat exchange coefficient by a threshold, setting off an alarm for heat exchange maintenance or stopping the system, wherein the threshold can be set by the user or a remote server or based on the environment.

8. The AC control method according to claim 7, wherein
the calculation data of the heat exchange coefficient includes outdoor air temperature, outdoor unit liquid outlet temperature, return inlet temperature, values of outdoor unit high pressure and low pressure.

9. The variable speed AC control method according to claim 8, wherein
the heat exchange coefficient can be for indoor heat exchange or outdoor heat exchange; and
in case of outdoor heat exchange, additional compressor discharge pressure and compressor discharge temperature are part of the calculation; and
in case of the AC system is variable speed system, addition compressor speed is part the calculation.

10. The AC control method according to claim 11, wherein
the alarm or system stop is triggered when the actual heat exchange coefficient has been lacking from the baseline heat exchange coefficient for several times.

11. A non-transitory computer-readable medium having stored thereon a set of computer-executable instructions for causing a first device to perform steps comprising:
calculating actual heat exchange coefficient for actual operation timing cycle based on sensor data from operation data and refrigerant lookup data, wherein the actual heat exchange coefficient is used to determine maintenance status.

12. The non-transitory computer-readable medium according to claim 11, further comprising:
calculating a baseline heat exchange coefficient after installation or maintenance; and
when the heat exchange coefficient is less than the baseline outdoor heat exchange coefficient by a threshold, setting off an alarm for heat exchange maintenance or stopping the system, wherein the threshold can be set by the user or a remote server or based on the environment.

13. The non-transitory computer-readable medium according to claim 12, wherein the calculation data of the heat exchange coefficient includes outdoor air temperature, outdoor unit liquid outlet temperature, return inlet temperature, values of outdoor unit high pressure and low pressure.

14. The non-transitory computer-readable medium according to claim 13, wherein the heat exchange coefficient can be for indoor heat exchange or outdoor heat exchange; and
in case of outdoor heat exchange, additional compressor discharge pressure and compressor discharge temperature are part of the calculation; and
in case of the AC system is variable speed system, addition compressor speed is part the calculation.

15. The non-transitory computer-readable medium according to claim 14, wherein the alarm or system stop is triggered when actual heat exchange coefficient has been lacking from the baseline heat exchange coefficient for several times.
